(19) United States
(12) Patent Application Publication
(10) Pub. No.: US 2026/0238704 A1
(43) Pub. Date: Aug. 13, 2026

(54) SYSTEM AND METHOD FOR DYNAMICALLY ROUTING USERS TO DIFFERENT VERSIONS OF AN APPLICATION IN REAL-TIME

(71) Applicant: BANK OF AMERICA CORPORATION, Charlotte, NC (US)

(72) Inventors: Nipun Mahajan, Lawrenceville, NJ (US); Shyam Acharya, Monroe Township, NJ (US); S.B. Pravin Kumar, Nagercoil (IN); Amit Mishra, Chennai (IN); Krithika Viswanathan, Chennai (IN)

(73) Assignee: BANK OF AMERICA CORPORATION, Charlotte, NC (US)

(21) Appl. No.: 19/048,539

(22) Filed: Feb. 7, 2025

(51) Int. Cl. H04L 67/63

(52) U.S. Cl. CPC H04L 67/63

(57) ABSTRACT

Embodiments of the present invention provide a system for dynamically routing users to different versions of an application in real-time. The system is configured to determine an unintended workflow associated with a current version of application that is deployed into production environment in a current release cycle, determine initiation of new sessions associated with the application by a plurality of users, calculate probability of initiation of the unintended workflow in the new sessions, determine a criticality score for the new sessions initiated by each of the plurality of users based on the probability, and automatically route each of the plurality of users to a previous version of the application associated with a previous release cycle or the current version of the application associated with the current release cycle based on the criticality score for the new sessions initiated by each of the plurality of users.

### BACKGROUND

There exists a need for a system that can route users to different versions of an application in real-time.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for dynamically routing users to different versions of an application in real-time. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention determines at least one unintended workflow associated with a current version of an application that is deployed into production environment in a current release cycle, in response to determining the at least one unintended workflow, continuously monitors and determines initiation of one or more new sessions by a plurality of users, calculates probability of initiation of the at least one unintended workflow in the one or more new sessions initiated by each of the plurality of users, determines a criticality score for the one or more new sessions initiated by each of the plurality of users based on the probability of initiation of the at least one unintended workflow, and automatically routes each of the plurality of users to a previous version of the application associated with a previous release cycle or the current version of the application associated with the current release cycle based on the criticality score for the one or more new sessions initiated by each of the plurality of users.

In some embodiments, the present invention determining the at least one unintended workflow comprises generating one or more action intent workflows of one or more previous sessions initiated by least one user for accessing one or more features of the application, wherein the one or more action intent workflows are associated with usage of the one or more features of the application that were deployed into the production environment in the previous release cycle, determining first set of expected workflows associated with the one or more features that were deployed into the production environment in the previous release cycle, identifying one or more new requirements associated with the current release cycle for development of program code of the application, wherein the one or more new requirements are associated with one or more new features or modifications of the one or more features, determining a second set of expected workflows for the one or more new requirements associated with the current release cycle, determining delta changes between the first set of expected workflows of the previous release cycle and the second set of expected workflows of the current release cycle, monitoring and generating one or more new action intent workflows associated with one or more current sessions initiated by the at least one user for accessing the application after deployment of the program code associated with the current release cycle into the production environment, and determining the at least one unintended workflow based on the delta changes, the second set of expected workflows, and the one or more new action intent workflows.

In some embodiments, the present invention generates the one or more action intent workflows based on extracting one or more action logs associated with one or more actions of the at least one user while accessing the one or more features of the application that were deployed in the previous release cycle, identifying one or more corresponding code changes associated with each of the one or more actions recorded in the action logs, and generating the one or more action intent workflows based on the one or more action logs and the one or more corresponding code changes.

In some embodiments, the present invention determines the first set of expected workflows associated with the previous release cycle based on one or more previous requirements associated with the previous release cycle and one or more previous test cases associated with the one or more previous requirements.

In some embodiments, the present invention determines the second set of expected workflows based on the one or more new requirements associated with the current release cycle, one or more new test cases associated with the one or more new requirements of the current release cycle, and the one or more previous test cases associated with the one or more previous requirements.

In some embodiments, the present invention generates one or more new action intent workflows associated with one or more current sessions initiated by the at least one user for accessing the application after deployment of the program code associated with the current release cycle into the production environment based on extracting one or more current action logs associated with one or more current actions of the at least one user while accessing the application comprising the program code that is deployed in the current release cycle.

In some embodiments, the present invention calculates the probability of initiation of the at least one unintended workflow in the one or more new sessions initiated by each of the plurality of users based on extracting historical action intent workflows associated with each of the plurality of users, generating one or more future action intent workflows for each of the plurality of users based on the historical action intent workflows, calculating probabilities of each intent in the one or more future action intent workflows for each of the plurality of users, and calculating the probability of initiation of the at least one unintended workflow based on the probabilities of the each intent in the one or more future action intent workflows.

In some embodiments, the present invention automatically routes each of the plurality of users to the previous version of the application associated with the previous release cycle for the one or more new sessions initiated by each of the plurality of users based on determining that the criticality score is above a defined threshold value.

In some embodiments, the present invention automatically routes each of the plurality of users to the current version of the application associated with the current release cycle for the one or more new sessions initiated by each of the plurality of users based on determining that the criticality score is below a defined threshold value.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for dynamically routing users to different versions of an application in real-time, in accordance with an embodiment of the invention;

FIG. 2 provides a block diagram illustrating the entity system 200 of FIG. 1, in accordance with an embodiment of the invention;

FIG. 3 provides a block diagram illustrating a dynamic routing system 300 of FIG. 1, in accordance with an embodiment of the invention;

FIG. 4 provides a block diagram illustrating the computing device system 400 of FIG. 1, in accordance with an embodiment of the invention;

FIGS. 5A and 5B provide a process flow for dynamically routing users to different versions of an application in real-time, in accordance with an embodiment of the invention; and

FIG. 6 provides a block diagram illustrating the process of dynamically routing users to different versions of an application in real-time, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that develops, tests, manages, maintains, uses, and/or the like one or more software applications for performing one or more activities associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution. As described herein, a “user” may be an employee, a customer, or a potential customer of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, when new program code changes of an application associated with new requirements for a current release cycle are deployed into a production environment, there is a possibility that errors not previously identified in the testing environment may be detected post-deployment. Such errors detected after deploying the new changes to the production environment have to be immediately resolved to support one or more application users trying to access the application. However, resolving the errors may be a time taking process and cannot be expedited as it may result in additional issues. Current conventional systems typically revert the code changes that were deployed to the production environment in the current release cycle. A drawback with such an approach is that users trying to access part of the new changes (associated with the new requirements of the current release cycle) that are not associated with the errors may be denied access. As such, there exists a need for a system that overcomes these technical challenges.

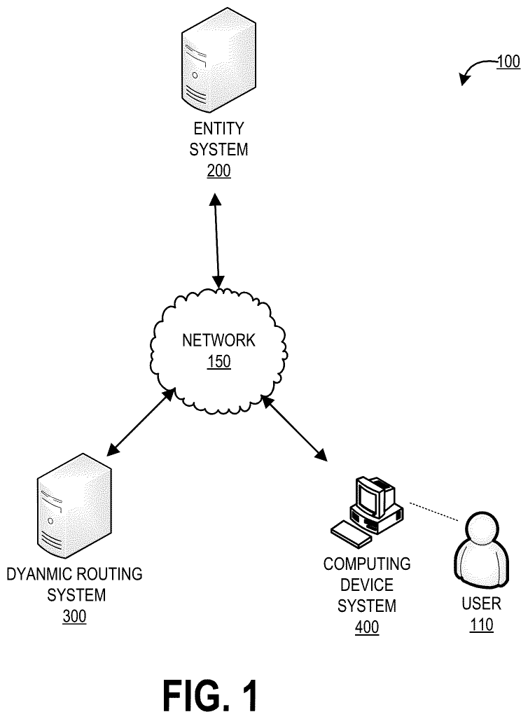

FIG. 1 provides a block diagram illustrating a system environment 100 for dynamically routing users to different versions of an application in real-time, in accordance with an embodiment of the invention. As illustrated in FIG. 1, the environment 100 includes an dynamic routing system 300, an entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200. In some embodiments, the one or more users 110 may be potential customers of the entity associated with the entity system 200. In some embodiments, the one or more users 110 may be employees of the entity associated with the entity system 200.

The entity system(s) 200 may be any system owned or otherwise controlled by an entity to support or perform one or more process steps described herein. In some embodiments, the entity may be any organization that develops, tests, manages, maintains, uses, and/or the like one or more software applications for performing one or more activities associated with the entity. In some embodiments, the entity is a financial institution. In some embodiments, the entity is a non-financial institution.

The dynamic routing system 300 is a system of the present invention for performing one or more process steps described herein. In some embodiments, the dynamic routing system 300 may be an independent system. In some embodiments, the dynamic routing system 300 may be a part of the entity system 200. In some embodiments, the dynamic routing system 300 may be controlled, owned, managed, and/or maintained by the entity associated with the entity system 200.

The dynamic routing system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the dynamic routing system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the dynamic routing system 300, and/or entity system 200 across the network 150.

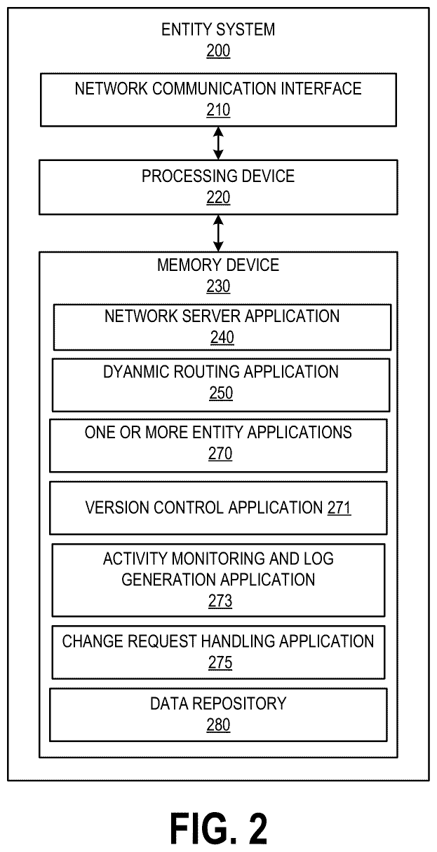

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution or a non-financial institution.

It should be understood that the memory device 230 may include one or more databases or other data structures/repositories. The memory device 230 also includes computer-executable program code that instructs the processing device 220 to perform one or more processing functionalities described herein and also to operate the network communication interface 210 to perform certain communication functions of the entity system 200 described herein. For example, in one embodiment of the entity system 200, the memory device 230 includes, but is not limited to, a dynamic routing application 250, one or more entity applications 270, a version control application 271, an activity monitoring and log generation application 273, a change request handling application 275, and a data repository 280. The one or more entity applications 270 may be any applications developed, deployed, tested, supported, maintained, utilized, managed, and/or controlled by the entity. The version control application 271 may store one or more program codes associated with entity applications 270 developed, deployed, tested, maintained, controlled, managed, and/or the like by the entity and control versions of the entity applications 270. The activity monitoring and log generation application 273 may monitor one or more user actions associated with usage of the entity application 270 and store the one or more user actions in one or more action logs for each application session initiated by the user 110. The change request handling application 275 may receive, maintain, manage, document, track, and/or the like one or more requirements associated with development of one or more features of the entity applications 270 that may be developed and deployed over a plurality of release cycles. The computer-executable program code of the network server application 240, the dynamic routing application 250, the version control application 271, the activity monitoring and log generation application 273, the change request handling application 275, and the one or more entity application 270 to perform certain logic, data-extraction, and data-storing functions of the entity system 200 described herein, as well as communication functions of the entity system 200.

The network server application 240, the dynamic routing application 250, the version control application 271, the activity monitoring and log generation application 273, the change request handling application 275, and the one or more entity applications 270 are configured to store data in the data repository 280 or to use the data stored in the data repository 280 when communicating through the network communication interface 210 with the dynamic routing system 300, and/or the computing device system 400 to perform one or more process steps described herein. In some embodiments, the entity system 200 may receive instructions from the dynamic routing system 300 via the dynamic routing application 250 to perform certain operations. The dynamic routing application 250 may be provided by the dynamic routing system 300. The one or more entity applications 270 may be any of the applications used, created, modified, facilitated, developed, and/or managed by the entity system 200.

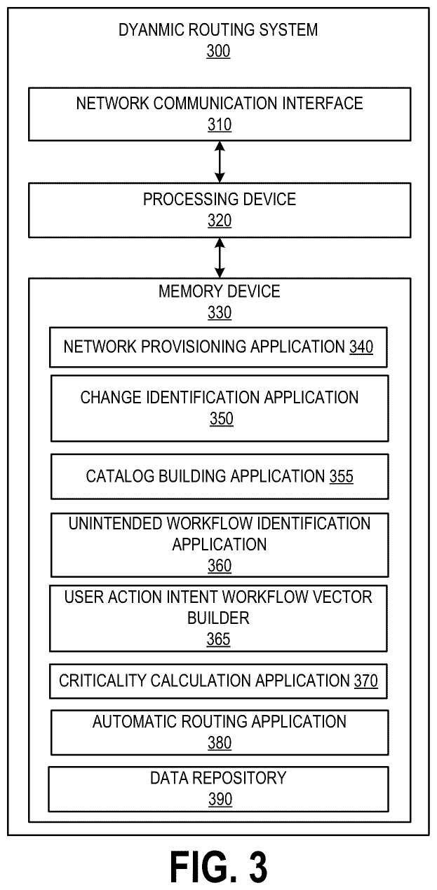

FIG. 3 provides a block diagram illustrating the dynamic routing system 300 in greater detail, in accordance with embodiments of the invention. As illustrated in FIG. 3, in one embodiment of the invention, the dynamic routing system 300 includes one or more processing devices 320 operatively coupled to a network communication interface 310 and a memory device 330. In certain embodiments, the dynamic routing system 300 is operated by an entity, such as a financial institution. In some embodiments, the dynamic routing system 300 is owned or operated by the entity of the entity system 200. In some embodiments, the dynamic routing system 300 may be an independent system. In alternate embodiments, the dynamic routing system 300 may be a part of the entity system 200.

It should be understood that the memory device 330 may include one or more databases or other data structures/repositories. The memory device 330 also includes computer-executable program code that instructs the processing device 320 to perform processing operations described herein and to operate the network communication interface 310 to perform certain communication functions of the dynamic routing system 300. For example, in one embodiment of the dynamic routing system 300, the memory device 330 includes, but is not limited to, a network provisioning application 340, a change identification application 350, a catalog building application 355, an unintended workflow identification application 360, a user action intent workflow vector builder 365, a criticality calculation application 370, an automatic routing application 380, and a data repository 390 comprising any data processed or accessed by one or more applications in the memory device 330. The computer-executable program code of the network provisioning application 340, the change identification application 350, the catalog building application 355, the unintended workflow identification application 360, the user action intent workflow vector builder 365, the criticality calculation application 370, and the automatic routing application 380 may instruct the processing device 320 to perform certain logic, data-processing, and data-storing functions of the dynamic routing system 300 described herein, as well as communication functions of the dynamic routing system 300.

The network provisioning application 340, the change identification application 350, the catalog building application 355, the unintended workflow identification application 360, the user action intent workflow vector builder 365, the criticality calculation application 370, and the automatic routing application 380 are configured to invoke or use the data in the data repository 390 when communicating through the network communication interface 310 with the entity system 200, and/or the computing device system 400. In some embodiments, the network provisioning application 340, the change identification application 350, the catalog building application 355, the unintended workflow identification application 360, the user action intent workflow vector builder 365, the criticality calculation application 370, and the automatic routing application 380 may store the data extracted or received from the entity system 200, and the computing device system 400 in the data repository 390. In some embodiments, the network provisioning application 340 the change identification application 350, the catalog building application 355, the unintended workflow identification application 360, the user action intent workflow vector builder 365, the criticality calculation application 370, and the automatic routing application 380 may be a part of a single application (e.g., modules).

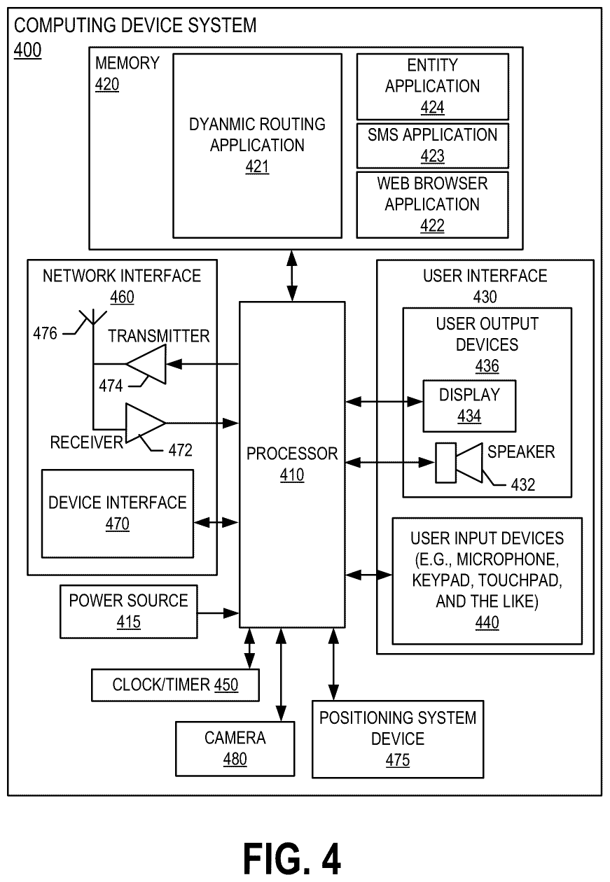

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a dynamic routing application 421, entity application 424. These applications also typically instructions to a graphical user interface (GUI) on the display 430 that allows the user 110 to interact with the entity system 200, the dynamic routing system 300, and/or other devices or systems. The memory 420 of the computing device system 400 may comprise a Short Message Service (SMS) application 423 configured to send, receive, and store data, information, communications, alerts, and the like via the wireless network. In some embodiments, the dynamic routing application 421 provided by the dynamic routing system 300 allows the user 110 to access the dynamic routing system 300. In some embodiments, the entity application 424 provided by the entity system 200 and the dynamic routing application 421 allow the user 110 to access the functionalities provided by the dynamic routing system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

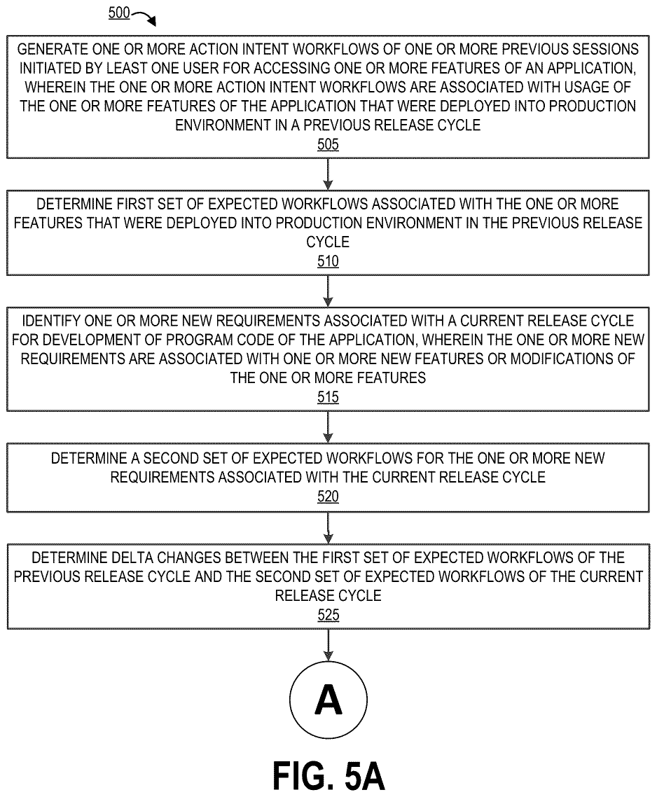

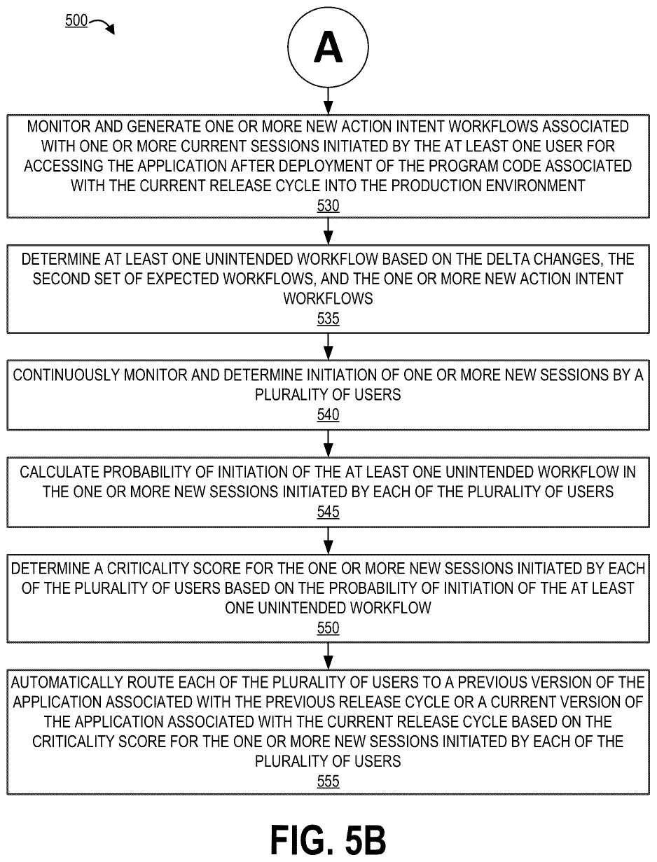

FIGS. 5A and 5B provide a process flow for dynamically routing users to different versions of an application in real-time, in accordance with an embodiment of the invention. As shown in block 505, the system generates one or more action intent workflows of one or more previous sessions initiated by least one user for accessing one or more features of an application, wherein the one or more action intent workflows are associated with usage of the one or more features of the application that were deployed into production environment in a previous release cycle. The one or more action intent workflows may be generated based on extracting one or more action logs associated with one or more actions of the at least one user while accessing the one or more features of the application that were deployed in the previous release cycle, identifying one or more corresponding code changes associated with each of the one or more actions recorded in the action logs, and generating the one or more action intent workflows based on the one or more action logs and the one or more corresponding code changes.

The one or more action intent workflows may comprise a series of actions performed by the at least one user to access one or more features of the application for achieving a specific intent. For example, intent of a user may comprise checking balance of a savings account in an online banking application, where the action intent workflow associated with achieving intent comprises logging into the online banking application, clicking on the savings account, and clicking view balance option. It should be understood that the examples provided herein are for explanatory purposes only and in no way delineate the scope of the invention. There may be multiple action intent workflows for a single intent, where each user may perform a different action intent workflow for achieving the intent. Continuing with the previous example, a second user may achieve the intent of checking balance of the savings account in the online banking application by an action intent workflow comprising logging into the online banking application, scrolling to the savings account upon landing on home page of the online banking application, and checking balance of the savings account on the home page.

As shown in block 510, the system determines first set of expected workflows associated with the one or more features that were deployed into production environment in the previous release cycle. In some embodiments, the system determine the first set of expected workflows associated with the previous release cycle based on one or more previous requirements associated with the previous release cycle and one or more previous test cases associated with the one or more previous requirements. The system may extract test cases associated with previous release cycle and correlate the test cases with the requirements of the previous release cycle to determine the first set of expected workflows. For example, previous requirements associated with previous release cycle may comprise generating a new page in a web application to allow a user to submit images to the web application, where the new page comprises an upload option and a submit option. The system may determine the expected flow associated with the previous release cycle as upon logging into the web application, the new page comprising the upload option and the submit option is displayed to a user accessing the web application, where the user clicks on the upload option to select an image and click on the submit button to submit the image to the web application.

As shown in block 515, the system identifies one or more new requirements associated with a current release cycle for development of program code of the application, wherein the one or more new requirements are associated with one or more new features or modifications of the one or more features. Continuing with the previous example, the one or more new requirements associated with the current release cycle comprise applying blue color to the upload button and green color to the submit button and displaying a message after user submits the image, where the message comprises whether the submission was successful.

As shown in block 520, the system determines a second set of expected workflows for the one or more new requirements associated with the current release cycle. In some embodiments, the system may determine the second set of expected workflows based on the one or more new requirements associated with the current release cycle, one or more new test cases associated with the one or more new requirements of the current release cycle, and the one or more previous test cases associated with the one or more previous requirements. Continuing with the previous example, the system may determine that the second set of expected workflow associated with the current release cycle may comprise upon logging into the web application, (i) the new page comprising a blue upload option and a green submit option is displayed to the user accessing the web application, where the user clicks on the blue upload option to select an image and clicks on the green submit option to submit the image to the web application and (ii) a message is displayed which updates the user whether submission of the image was successful or not.

As shown in block 525, the system determines delta changes between the first set of expected workflows of the previous release cycle and the second set of expected workflows of the current release cycle. The delta changes may be identified based on comparing the first set of expected workflows of the previous release cycle and the second set of expected workflows of the current release cycle. Continuing with the previous example, delta changes between the previous release cycle and the current release cycle may comprise the blue upload button, green submit button, display of message associated with whether submission of the image was successful or not.

As shown in block 530, the system monitors and generates one or more new action intent workflows associated with one or more current sessions initiated by the at least one user for accessing the application after deployment of the program code associated with the current release cycle into the production environment. In some embodiments, the system may generate one or more new action intent workflows associated with one or more current sessions initiated by the at least one user for accessing the application after deployment of the program code associated with the current release cycle into the production environment based on extracting one or more current action logs associated with one or more current actions of the at least one user while accessing the application comprising the program code that is deployed in the current release cycle. Continuing with the previous example, the system may determine that a first user is initiating a current session using the current version of the web application and extract action logs associated with the current session to generate the new action intent workflow which comprises the first user logging into the web application, upon logging into the web application, the new page comprising a red upload option and a yellow submit option is displayed to the user accessing the web application, where the user clicks on the red upload option to select an image and then clicks on the yellow submit option to submit the image to the web application, and a message is displayed which updates the user whether submission of the image was successful or not.

As shown in block 535, the system determines at least one unintended workflow based on the delta changes, the second set of expected workflows, and the one or more new action intent workflows. The system may identify any deviations from the second set of expected workflows in the one or more new action intent workflows associated with the current session initiated by the at least one user for accessing the application after deployment of the program code associated with the current release cycle into the production environment. Continuing with the previous example, the system may determine the unintended workflow as display of the red upload option instead of blue upload option and display of yellow submit option instead of green submit option.

As shown in block 540, the system continuously monitors and determines initiation of one or more new sessions by a plurality of users. Upon detecting the unintended workflow, the system may identify all new sessions initiated by plurality of users after the detection of the unintended workflow.

As shown in block 545, the system calculates probability of initiation of the at least one unintended workflow in the one or more new sessions initiated by each of the plurality of users. In some embodiments, the system calculate the probability of initiation of the at least one unintended workflow in the one or more new sessions initiated by each of the plurality of users based on extracting historical action intent workflows associated with each of the plurality of users, generating one or more future action intent workflows for each of the plurality of users based on the historical action intent workflows, calculating probabilities of each intent in the one or more future action intent workflows for each of the plurality of users, and calculating the probability of initiation of the at least one unintended workflow based on the probabilities of the each intent in the one or more future action intent workflows. Continuing with the previous example, the system may determine that probability of a second user accessing the new page to submit an image is 10% as the first user typically does not upload images, instead just reviews images uploaded by users, based on historical data, user information associated with the second user, and/or the like. In another example, the system may determine that probability of a third user accessing the new page to submit an image is 98% based on historical data, user information, and/or the like associated with the third user.

In some embodiments, the system may divide all users associated with the entity into a plurality of clusters, where probability of each cluster initiating the unintended workflow is pre-processed based on historical data, historical action intent workflows, user information, and/or the like. In such embodiments, the system may determine that a fourth user is logging into the web application and may determine that the fourth user is associated with a first cluster that has 80% probability of accessing the unintended workflow to instantaneously calculate probability of the fourth user accessing the unintended workflow as 80%.

As shown in block 550, the system determines a criticality score for the one or more new sessions initiated by each of the plurality of users based on the probability of initiation of the at least one unintended workflow. The criticality score defines criticality of initiation of the at least one unintended workflow in the one or more new sessions. Based on the previously disclosed examples, the system may determine criticality score associated with the second user to be low and criticality score associated with the third user to be very high.

As shown in block 555, the system automatically routes each of the plurality of users to a previous version of the application associated with the previous release cycle or a current version of the application associated with the current release cycle based on the criticality score for the one or more new sessions initiated by each of the plurality of users. In some embodiments, the system automatically routes each of the plurality of users to the previous version of the application associated with the previous release cycle for the one or more new sessions initiated by each of the plurality of users based on determining that the criticality score is above a defined threshold value (e.g., high). Continuing with the previous example associated with the third user, the system routes the third user to the previous version of the application. In some other embodiments, the system automatically routes each of the plurality of users to the current version of the application associated with the current release cycle for the one or more new sessions initiated by each of the plurality of users based on determining that the criticality score is below a defined threshold value (e.g., low). Continuing with the previously disclosed example associated with the second user, the system routes the second user to the current version of the application.

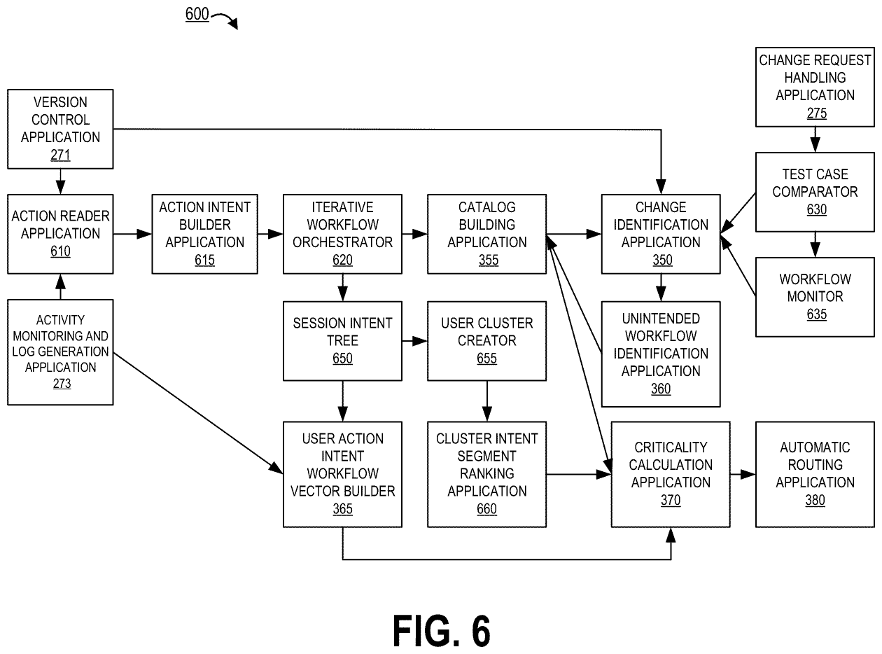

FIG. 6 provides a block diagram illustrating the process of dynamically routing users to different versions of an application in real-time, in accordance with an embodiment of the invention. As shown, the action reader application 610 extracts data from the version control application 271 comprising program codes of the application and the activity monitoring and log generation application 273 comprising action logs associated with one or more actions taken by the at least one user and transmits the data to the action intent builder application 615. Based on the action logs, the action intent builder application 615 determines intent of the at least one user in one or more previous sessions. The action intent builder application 615 also determines a corresponding program code of the application accessed by the user to achieve the identified intent based on the program codes extracted from the version control application 271 by the action reader application 610. Based on the intent and mapping of the corresponding program codes, the iterative workflow orchestrator 620 generates one or more action intent workflows comprising a series of steps or actions taken by the at least one user to achieve the intent with corresponding program codes tagged to each of the steps. The catalog building application 355, generates a catalog comprising one or more features and capabilities of the application. The catalog building application 355 also stores the one or more action intent workflows generated by the iterative workflow orchestrator 620. In some embodiments, the catalog building application 355 may also verify based on the one or more action intent workflows that one or more features associated with the application are working without any errors and cross reference the one or more action intent workflows with one or more requirements associated with all of the previous release cycles of the application.

As shown, the test case comparator 630 extracts one or more requirements associated with the current release cycle from the change request handling application 275, extracts test cases associated with the previous release cycle, test cases associated with the current release cycle to identify the changes between the previous release cycle and the current release cycle and to determine if the changes align with the one or more new requirements extracted from the change request handling application 275. The workflow monitor 635 determines current expected workflow associated with the one or more new requirements. The change identification application 350 takes input from the version control application (program codes of the application), the catalog building application 355 (information associated with the one or more features and capabilities of the application), the test case comparator 630 (the one or more changes identified and the one or more requirements associated with the one or more identified changes), and the workflow monitor 635 (the current expected workflows associated with the one or more new requirements and one or more current test cases associated with the current release cycle) to determine delta changes between a previous version of application associated with a previous release cycle and a current version of the application associated with the current release cycle. After deployment of program code into the production environment, the action reader application 610, the action intent builder application 615, and the iterative workflow orchestrator 620 repeat the steps described above to generate one or more new action intent workflows associated with new sessions initiated by the at least one user. The unintended workflow identification application 360 determines at least one unintended workflow based on the delta changes, the current expected workflows, and the one or more new action intent workflows.

The session intent tree 650 stores intent associated with one or more historical sessions associated with the previous release cycle and current sessions associated with the current release cycle initiated by the at least one user. The user cluster creator 655 identifies a cluster of users associated with the same intent and series of steps/actions used to achieve the intent from intent data stored in the session intent tree 650. The cluster intent segment ranking application 660 determines probabilities of each intent and probabilities of each of the series of the steps associated with each intent that the cluster of users are likely to perform in future sessions. Based on the intent data in the session intent tree 650, the user action intent workflow vector builder 365 builds vectors associated with the intents associated with the at least one user.

The criticality calculation application 370 calculates the criticality score associated with probability of initiation of the at least one unintended workflow identified by the unintended workflow identification application 360 in future sessions by a plurality of users based on taking input from the user action intent workflow vector builder 365, the cluster intent segment ranking application 660 and the catalog building application 355. Based on the criticality score, the automatic routing application 380 routes the plurality of users initiating the predicted future sessions to the previous version or the current version of the application.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for dynamically routing users to different versions of an application in real-time, the system comprising:
at least one network communication interface;
at least one non-transitory storage device; and
at least one processing device coupled to the at least one non-transitory storage device and the at least one network communication interface, wherein the at least one processing device is configured to:
determine at least one unintended workflow associated with a current version of an application that is deployed into production environment in a current release cycle;
in response to determining the at least one unintended workflow, continuously monitor and determine initiation of one or more new sessions by a plurality of users;
calculate probability of initiation of the at least one unintended workflow in the one or more new sessions initiated by each of the plurality of users;
determine a criticality score for the one or more new sessions initiated by each of the plurality of users based on the probability of initiation of the at least one unintended workflow; and
automatically route each of the plurality of users to a previous version of the application associated with a previous release cycle or the current version of the application associated with the current release cycle based on the criticality score for the one or more new sessions initiated by each of the plurality of users.

2. The system of claim 1, wherein determining the at least one unintended workflow comprises:
generating one or more action intent workflows of one or more previous sessions initiated by at least one user for accessing one or more features of the application, wherein the one or more action intent workflows are associated with usage of the one or more features of the application that were deployed into the production environment in the previous release cycle;
determining first set of expected workflows associated with the one or more features that were deployed into the production environment in the previous release cycle;
identifying one or more new requirements associated with the current release cycle for development of program code of the application, wherein the one or more new requirements are associated with one or more new features or modifications of the one or more features;
determining a second set of expected workflows for the one or more new requirements associated with the current release cycle;
determining delta changes between the first set of expected workflows of the previous release cycle and the second set of expected workflows of the current release cycle;
monitoring and generating one or more new action intent workflows associated with one or more current sessions initiated by the at least one user for accessing the application after deployment of the program code associated with the current release cycle into the production environment; and
determining the at least one unintended workflow based on the delta changes, the second set of expected workflows, and the one or more new action intent workflows.

3. The system of claim 2, wherein the at least one processing device is configured to generate the one or more action intent workflows based on:
extracting one or more action logs associated with one or more actions of the at least one user while accessing the one or more features of the application that were deployed in the previous release cycle;
identifying one or more corresponding code changes associated with each of the one or more actions recorded in the action logs; and
generating the one or more action intent workflows based on the one or more action logs and the one or more corresponding code changes.

4. The system of claim 2, wherein the at least one processing device is configured to determine the first set of expected workflows associated with the previous release cycle based on one or more previous requirements associated with the previous release cycle and one or more previous test cases associated with the one or more previous requirements.

5. The system of claim 4, wherein the at least one processing device is configured to determine the second set of expected workflows based on the one or more new requirements associated with the current release cycle, one or more new test cases associated with the one or more new requirements of the current release cycle, and the one or more previous test cases associated with the one or more previous requirements.

6. The system of claim 2, wherein the at least one processing device is configured to generate one or more new action intent workflows associated with one or more current sessions initiated by the at least one user for accessing the application after deployment of the program code associated with the current release cycle into the production environment based on extracting one or more current action logs associated with one or more current actions of the at least one user while accessing the application comprising the program code that is deployed in the current release cycle.

7. The system of claim 1, wherein the at least one processing device is configured to calculate the probability of initiation of the at least one unintended workflow in the one or more new sessions initiated by each of the plurality of users based on:
extracting historical action intent workflows associated with each of the plurality of users;
generating one or more future action intent workflows for each of the plurality of users based on the historical action intent workflows;
calculating probabilities of each intent in the one or more future action intent workflows for each of the plurality of users; and
calculating the probability of initiation of the at least one unintended workflow based on the probabilities of the each intent in the one or more future action intent workflows.

8. The system of claim 1, wherein the at least one processing device is configured to automatically route each of the plurality of users to the previous version of the application associated with the previous release cycle for the one or more new sessions initiated by each of the plurality of users based on determining that the criticality score is above a defined threshold value.

9. The system of claim 1, wherein the at least one processing device is configured to automatically route each of the plurality of users to the current version of the application associated with the current release cycle for the one or more new sessions initiated by each of the plurality of users based on determining that the criticality score is below a defined threshold value.

10. A computer program product for dynamically routing users to different versions of an application in real-time, the computer program product comprising a non-transitory computer-readable storage medium having computer executable instructions for causing a computer processor to perform the steps of:
determining at least one unintended workflow associated with a current version of an application that is deployed into production environment in a current release cycle;
in response to determining the at least one unintended workflow, continuously monitoring and determine initiation of one or more new sessions by a plurality of users;
calculating probability of initiation of the at least one unintended workflow in the one or more new sessions initiated by each of the plurality of users;
determining a criticality score for the one or more new sessions initiated by each of the plurality of users based on the probability of initiation of the at least one unintended workflow; and
automatically routing each of the plurality of users to a previous version of the application associated with a previous release cycle or the current version of the application associated with the current release cycle based on the criticality score for the one or more new sessions initiated by each of the plurality of users.

11. The computer program product of claim 10, wherein determining the at least one unintended workflow comprises:
generating one or more action intent workflows of one or more previous sessions initiated by at least one user for accessing one or more features of the application, wherein the one or more action intent workflows are associated with usage of the one or more features of the application that were deployed into the production environment in the previous release cycle;
determining first set of expected workflows associated with the one or more features that were deployed into the production environment in the previous release cycle;
identifying one or more new requirements associated with the current release cycle for development of program code of the application, wherein the one or more new requirements are associated with one or more new features or modifications of the one or more features;
determining a second set of expected workflows for the one or more new requirements associated with the current release cycle;
determining delta changes between the first set of expected workflows of the previous release cycle and the second set of expected workflows of the current release cycle;
monitoring and generating one or more new action intent workflows associated with one or more current sessions initiated by the at least one user for accessing the application after deployment of the program code associated with the current release cycle into the production environment; and
determining the at least one unintended workflow based on the delta changes, the second set of expected workflows, and the one or more new action intent workflows.

12. The computer program product of claim 11, wherein the computer executable instructions cause the computer processor to perform the step of generating the one or more action intent workflows based on:
extracting one or more action logs associated with one or more actions of the at least one user while accessing the one or more features of the application that were deployed in the previous release cycle;
identifying one or more corresponding code changes associated with each of the one or more actions recorded in the action logs; and
generating the one or more action intent workflows based on the one or more action logs and the one or more corresponding code changes.

13. The computer program product of claim 11, wherein the computer executable instructions cause the computer processor to perform the step of determining the first set of expected workflows associated with the previous release cycle based on one or more previous requirements associated with the previous release cycle and one or more previous test cases associated with the one or more previous requirements.

14. The computer program product of claim 13, wherein the computer executable instructions cause the computer processor to perform the step of determining the second set of expected workflows based on the one or more new requirements associated with the current release cycle, one or more new test cases associated with the one or more new requirements of the current release cycle, and the one or more previous test cases associated with the one or more previous requirements.

15. The computer program product of claim 14, wherein the computer executable instructions cause the computer processor to perform the steps of generating one or more new action intent workflows associated with one or more current sessions initiated by the at least one user for accessing the application after deployment of the program code associated with the current release cycle into the production environment based on extracting one or more current action logs associated with one or more current actions of the at least one user while accessing the application comprising the program code that is deployed in the current release cycle.

16. The computer program product of claim 10, wherein the computer executable instructions cause the computer processor to perform the step of calculating the probability of initiation of the at least one unintended workflow in the one or more new sessions initiated by each of the plurality of users based on:
extracting historical action intent workflows associated with each of the plurality of users;
generating one or more future action intent workflows for each of the plurality of users based on the historical action intent workflows;
calculating probabilities of each intent in the one or more future action intent workflows for each of the plurality of users; and
calculating the probability of initiation of the at least one unintended workflow based on the probabilities of the each intent in the one or more future action intent workflows.

17. A computer implemented method for dynamically routing users to different versions of an application in real-time, wherein the method comprises:
determining at least one unintended workflow associated with a current version of an application that is deployed into production environment in a current release cycle;
in response to determining the at least one unintended workflow, continuously monitoring and determine initiation of one or more new sessions by a plurality of users;
calculating probability of initiation of the at least one unintended workflow in the one or more new sessions initiated by each of the plurality of users;
determining a criticality score for the one or more new sessions initiated by each of the plurality of users based on the probability of initiation of the at least one unintended workflow; and
automatically routing each of the plurality of users to a previous version of the application associated with a previous release cycle or the current version of the application associated with the current release cycle based on the criticality score for the one or more new sessions initiated by each of the plurality of users.

18. The computer implemented method of claim 17, wherein determining the at least one unintended workflow comprises:
generating one or more action intent workflows of one or more previous sessions initiated by at least one user for accessing one or more features of the application, wherein the one or more action intent workflows are associated with usage of the one or more features of the application that were deployed into the production environment in the previous release cycle;
determining first set of expected workflows associated with the one or more features that were deployed into the production environment in the previous release cycle;
identifying one or more new requirements associated with the current release cycle for development of program code of the application, wherein the one or more new requirements are associated with one or more new features or modifications of the one or more features;
determining a second set of expected workflows for the one or more new requirements associated with the current release cycle;
determining delta changes between the first set of expected workflows of the previous release cycle and the second set of expected workflows of the current release cycle;
monitoring and generating one or more new action intent workflows associated with one or more current sessions initiated by the at least one user for accessing the application after deployment of the program code associated with the current release cycle into the production environment; and
determining the at least one unintended workflow based on the delta changes, the second set of expected workflows, and the one or more new action intent workflows.

19. The computer implemented method of claim 17, wherein calculating the probability of initiation of the at least one unintended workflow in the one or more new sessions initiated by each of the plurality of users comprises:
extracting historical action intent workflows associated with each of the plurality of users;
generating one or more future action intent workflows for each of the plurality of users based on the historical action intent workflows;
calculating probabilities of each intent in the one or more future action intent workflows for each of the plurality of users; and
calculating the probability of initiation of the at least one unintended workflow based on the probabilities of the each intent in the one or more future action intent workflows.

20. The computer implemented method of claim 17, wherein the method comprises automatically routing each of the plurality of users to the previous version of the application associated with the previous release cycle for the one or more new sessions initiated by each of the plurality of users based on determining that the criticality score is above a defined threshold value.
